(19) United States
(12) Patent Application Publication
(10) Pub. No.: US 2016/0118182 A1
(43) Pub. Date: Apr. 28, 2016

(54) ELECTRICAL CONNECTION APPARATUS

(71) Applicant: J.S.T. MFG. CO., LTD., Osaka-shi (JP)

(72) Inventors: Kunihiko YUKAWA, Miyoshi-shi (JP); Takeshi WATANABE, Miyoshi-shi (JP)

(73) Assignee: J.S.T. MFG. CO., LTD., Osaka-shi (JP)

(21) Appl. No.: 14/862,428

(22) Filed: Sep. 23, 2015

(30) Foreign Application Priority Data
Oct. 22, 2014 (JP) 2014-215111

(51) Int. Cl. H01F 27/29

(52) U.S. Cl. CPC H01F 27/29

(57) ABSTRACT

A contactless electrical connection apparatus that has a simple structure and can cover a broad spectrum is provided. The electrical connection apparatus is configured including a pair of connectors each having a conductive portion shaped as a loop that has a winding number of 1, with end portions of the conductive portion being provided as terminal portions. The pair of connectors are electrically connected by arranging the pair of conductive portions so as to oppose each other via a gap.

### CROSS-REFERENCE TO RELATED APPLICATION

This application is based upon and claims the benefit of priority from Japanese patent application No. 2014-215111. The entire disclosure of Japanese patent application No. 2014-215111 is hereby incorporated herein by reference.

### BACKGROUND OF THE INVENTION

1. Field of the Invention

The present invention relates to an electrical connection apparatus for electrically connecting the conductive portions of two connectors to each other without bringing them into contact with each other.

2. Description of Related Art

Conventionally, a so-called contactless electrical connection apparatus is known that can electrically connect a pair of conductive portions in a state of being separated and not in contact with each other. For example, JP 2013-214613A discloses an electrical power transmission apparatus that includes a power transmitting coil (or power receiving coil) that has a planar coil formed by winding a linear conductor into a spiral shape.

### SUMMARY OF THE INVENTION

However, the planar coil disclosed in JP 2013-214613A has a complicated structure due to being wound into a spiral shape as described above.

The present invention has been achieved in order to solve the above-described problems, and an object thereof is to provide a contactless electrical connection apparatus that has a simple structure and can cover a broad spectrum.

(1) In order to solve the above-described problems, an electrical connection apparatus according to an aspect of this invention includes: a pair of connectors each having a conductive portion shaped as a loop that has a winding number of 1, end portions of the conductive portion being provided as terminal portions, wherein the pair of connectors are electrically connected by the pair of conductive portions being arranged so as to oppose each other via a gap.

According to this configuration, when current flows in one conductive portion, change over time in the current is accompanied by the generation of a magnetic field that causes current to flow in the other conductive portion. In other words, even if the conductive portions of the pair of connectors are not brought into contact with each other, the pair of connectors can be electrically connected by electromagnetic induction (more specifically, mutual induction). Accordingly, the conductive portions can be covered by housings or the like so as to not be exposed to the outside, thus making it possible to provide an electrical connection apparatus that is superior in terms of water resistance, dust resistance, and the like.

Also, according to this configuration, the conductive portions are formed in the shape of a loop having a winding number of 1, thus making it possible to form the conductive portions with a very simple shape.

Furthermore, if the conductive portions are formed in the shape of a loop having a winding number of 1 as in this configuration, it is possible to broaden the transmittable frequency band, unlike the case of conductive portions formed in the shape of a spiral having multiple resonance points. Accordingly, it is possible to cover a broad spectrum with a single electrical connection apparatus.

Accordingly, this configuration makes it possible to provide a contactless electrical connection apparatus that has a simple structure and can cover a broad spectrum.

(2) It is preferable that each of the connectors further has an insulating housing that covers the conductive portion.

According to this configuration, by bringing the housings of the connectors into contact with each other, or arranging the housings so as to oppose each other via another member (substrate etc.) such that the pair of conductive portions oppose each other, the conductive portions of the connectors can be brought near each other while also preventing the pair of conductive portions from coming into contact with each other. Accordingly, it is possible to reduce the leakage to the outside of magnetic flux generated in the current flowing in the conductive portion in one of the connectors. It is therefore possible to reliably transmit a signal from one connector to the other connector.

(3) It is preferable that each of the conductive portions is formed such that a cross-section perpendicular to an extending direction of the conductive portion is shaped as a rectangle, and the pair of connectors are arranged such that long sides of the cross-sections oppose each other.

According to this configuration, wide-area portions of the pair of conductive portions oppose each other. Accordingly, it is possible to broaden the frequency band in which transmission can be performed by the pair of connectors. Furthermore, according to this configuration, even if there is a certain extent of positional misalignment when the pair of conductive portions oppose each other, it is possible to ensure the area of the opposing portions of the pair of conductive portions. In other words, this configuration makes it possible to provide an electrical connection apparatus that can permit a certain extent of arrangement misalignment of the pair of connectors, positional misalignment of the conductive portions accommodated in the housings relative to the housings, and the like. Note that the term “rectangle” recited above includes not only a rectangular shape, but also a shape obtained by chamfering the corner portions of a rectangle, for example.

(4) It is preferable that each of the conductive portions is formed in a shape of a circular ring.

According to this configuration, the ratio of the area of the portion surrounded by the conductive portion to the peripheral length of the conductive portion can be increased. This makes it possible to reduce the size of the conductive portion while also ensuring the transmittable frequency band of the electrical connection apparatus.

(5) It is further preferable that the pair of connectors are arranged such that central axes of the conductive portions formed in a shape of a circular ring are in a coaxial state.

According to this configuration, the magnetic flux formed by current flowing in one conductive portion is likely to penetrate the portion surrounded by the other conductive portion. It is therefore possible to more reliably transmit a signal from one connector to the other connector.

(6) It is preferable that each of the connectors further has a magnetic portion that is a magnetic body and at least partially comes into close contact with the conductive portion or comes into close contact with a coating portion formed on a surface of the conductive portion.

According to this configuration, the size of the connector can be reduced using the wavelength shortening effect.

Note that the above and other objects, features, and advantages of the present invention will become apparent by reading the following description with the attached drawings.

### BRIEF DESCRIPTION OF THE DRAWINGS

FIG. 1 is a schematic diagram showing electrical connection apparatuses according to an embodiment of the present invention along with two devices electrically connected by the electrical connection apparatuses.

FIG. 2A is a perspective view of one of the electrical connection apparatuses in FIG. 1, as seen from above.

FIG. 2B is the perspective view of FIG. 2A with conductive portions included therein illustrated by thin lines.

FIG. 3A is a perspective view of one of the connectors in FIG. 2A, as seen from above.

FIG. 3B is the perspective view of one of the connectors in FIG. 2A, as seen from below.

FIG. 4A is a perspective view of the shape of a magnetic portion.

FIG. 4B is a plan view of the shape of the magnetic portion.

FIG. 5A is a perspective view of the shape of a conductive portion.

FIG. 5B is a plan view of the shape of the conductive portion.

FIG. 6A is a diagram for describing the results of simulation of an eye pattern when a differential signal is input from one connector to the other connector by the electrical connection apparatus, and shows a state in which the terminal portions of the pair of connectors are arranged in directions that are 180 degrees opposite to each other.

FIG. 6B is a diagram for describing the results of simulation of an eye pattern when a differential signal is input from one connector to the other connector by the electrical connection apparatus, and these simulation results are for when the pair of connectors are connected in the state shown in FIG. 6A.

FIG. 7 is a cross-sectional diagram schematically showing only the magnetic portions and the conductive portions in a pair of connectors in the connected state, and this cross-sectional view is taken along a plane that includes the vertical direction.

FIG. 8A is a perspective view of the shape of a pair of conductive portions of an electrical connection apparatus according to a variation.

FIG. 8B is a plan view of the shape of the pair of conductive portions of the electrical connection apparatus according to the above variation.

FIG. 9A is a perspective view of the shape of a pair of conductive portions of an electrical connection apparatus according to a variation.

FIG. 9B is a plan view of the shape of the pair of conductive portions of the electrical connection apparatus according to the above variation.

FIG. 10A is a perspective view of the shape of a pair of conductive portions of an electrical connection apparatus according to a variation.

FIG. 10B is a plan view of the shape of the pair of conductive portions of the electrical connection apparatus according to the above variation.

FIG. 11A is a perspective view of the shape of a pair of conductive portions of an electrical connection apparatus according to a variation.

FIG. 11B is a plan view of the shape of the pair of conductive portions of the electrical connection apparatus according to the above variation.

FIG. 12A is a perspective view of the shape of a pair of conductive portions of an electrical connection apparatus according to a variation.

FIG. 12B is a plan view of the shape of the pair of conductive portions of the electrical connection apparatus according to the above variation.

FIG. 13A is a perspective view of the shape of a pair of conductive portions of an electrical connection apparatus according to a variation.

FIG. 13B is a plan view of the shape of the pair of conductive portions of the electrical connection apparatus according to the above variation.

### DETAILED DESCRIPTION OF THE INVENTION

Hereinafter, modes for carrying out the present invention will be described with reference to the drawings.

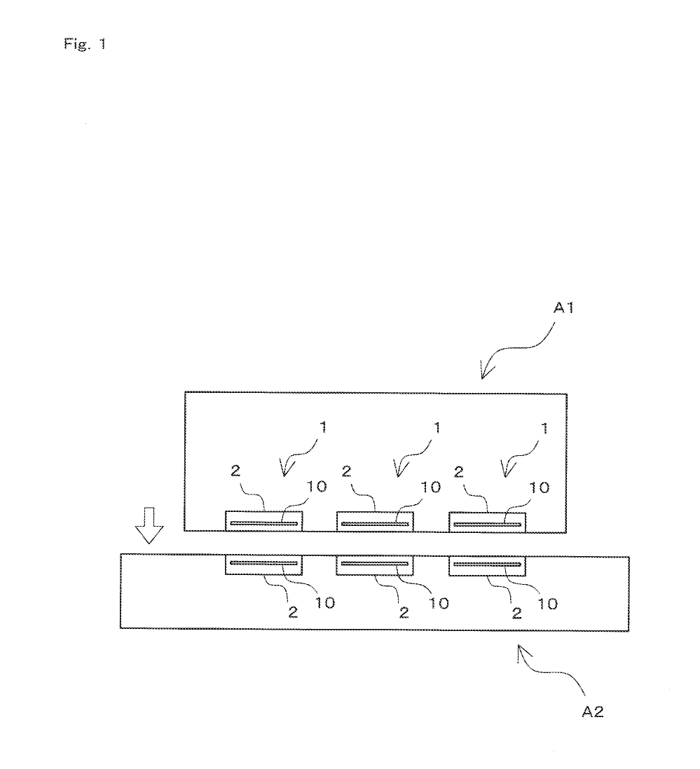

FIG. 1 is a schematic diagram showing electrical connection apparatuses 1 according to an embodiment along with two devices A1 and A2 that are electrically connected by the electrical connection apparatuses 1. As shown in FIG. 1, the electrical connection apparatus 1 of the present embodiment is used for electrically connecting the first device A1 to the second device A2. Also, as will be described in detail below, the electrical connection apparatus 1 according to this embodiment of the present invention includes a pair of connectors 2, and can electrically connect the connectors 2 without bringing conductive portions 10 of the connectors 2 into contact with each other. In other words, the electrical connection apparatus 1 according to the present embodiment is a so-called contactless electrical connection apparatus.

The electrical connection apparatus 1 is favorable in electrically connecting a notebook computer (the first device A1) to a so-called docking station (the second device A2), for example. Specifically, as shown in FIG. 1, when the notebook computer A1 is connected to the docking station A2, the connectors 2, 2, . . . provided on the notebook computer A1 are respectively electrically connected to the connectors 2, 2, . . . provided on the docking station A2. This enables the transmission of data between the notebook computer A1 and the docking station A2. However, the present invention is not limited in this way, and is broadly applicable to any contactless electrical connection apparatus that electrically connects two connection targets (first device and second device).

Overall Configuration

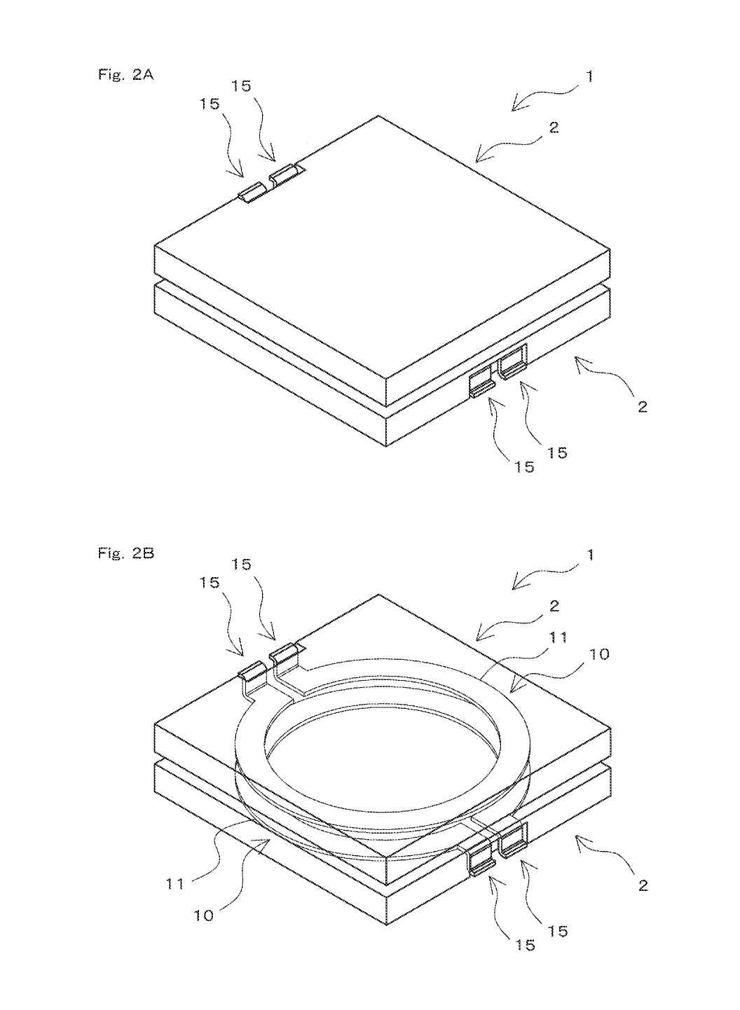

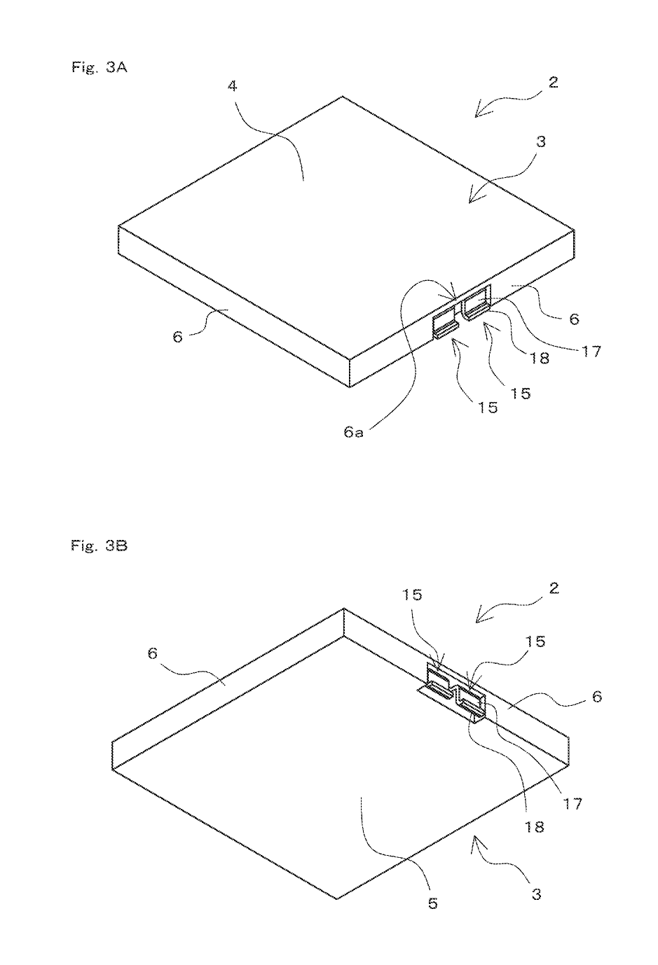

FIG. 2A is a perspective view of the electrical connection apparatus 1, as seen from above, and FIG. 2B is the perspective view of FIG. 2A with the conductive portions included therein illustrated by thin lines. Also, FIG. 3A is a perspective view of one of the connectors 2, as seen from above, and FIG. 3B is the perspective view of the connector 2, as seen from below. The electrical connection apparatus 1 according to the present embodiment includes two connectors 2 that have the same shape as each other.

Connector Configuration

As shown in FIGS. 2A and 2B, each connector 2 is formed so as to have a low thickness in the vertical direction, and so as to have an approximately square shape in a plan view (as seen in the vertical direction). The size of the connector 2 is 20 mm square, for example. The connector 2 has a housing 3, as well as a magnetic portion 7 and a conductive portion 10 that are accommodated in the housing 3. Note that the size of the connector is not limited to the size described above (20 mm square), and can be changed according to a user request, the frequency band of use, or the like.

The housing 3 is the portion that constitutes the outline of the connector 2, and is a portion formed by combining multiple members so as to be shaped as a thin cuboid box that has a space inside. The housing 3 is made of a resin material that has insulating properties. One example of the resin material used for the housing 3 is LCP (Liquid Crystal Polymer). However, the resin material used for the housing 3 is not limited to the above example, and other examples include a thermoplastic resin (e.g., vinyl chloride resin, polyethylene, polystyrene, ABS resin, acrylic resin, polypropylene, modified PPE, polycarbonate, polyamide, polyacetal, polybutylene terephthalate, polyphenylene-sulfide, liquid crystal polymer), and a thermosetting resin (e.g., phenol resin, urea resin, melamine resin, epoxy resin, polyurethane).

The housing 3 has an upper surface portion 4, a lower surface portion 5, and four side surface portions 6. The upper surface portion 4 is the surface portion on the upper side of the housing 3, and is formed with a square shape in a plan view. The lower surface portion 5 is the portion on the lower side of the housing 3, and is formed with a square shape in a plan view likewise to the upper surface portion 4. The lower surface portion 5 is provided so as to oppose the upper surface portion 4 with a slight gap from the upper surface portion 4 in the vertical direction. The four side surface portions 6 are provided so as to connect the upper surface portion 4 and the lower surface portion 5, and so as to be perpendicular to the upper surface portion 4 and the lower surface portion 5. An opening portion 6a is formed in the central portion of one of the four side surface portions 6, and a portion of the conductive portion 10 (specifically, terminal portions 15, 15 that will be described in detail later) are exposed to the outside of the housing 3 via the opening portion 6a.

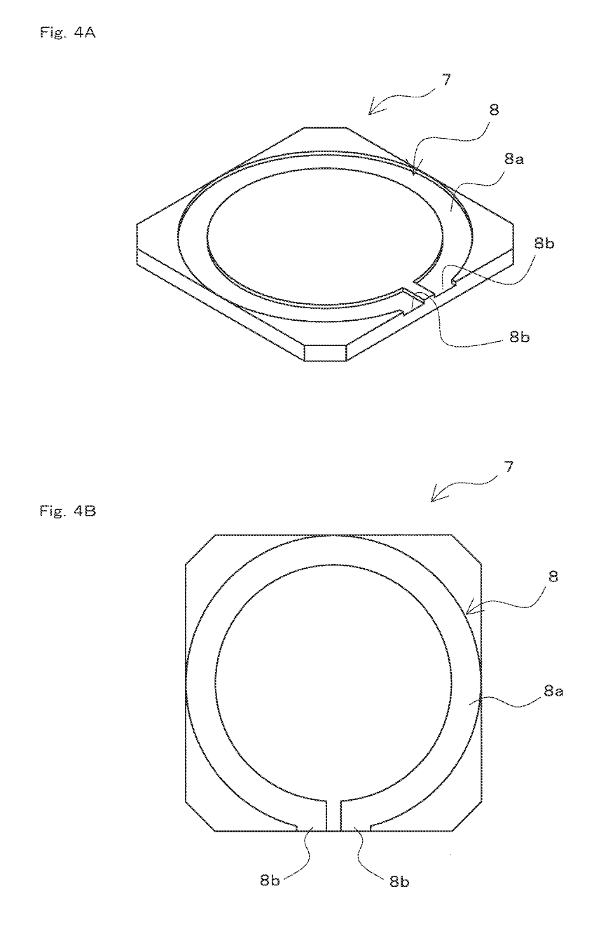

FIG. 4A is a perspective view of the shape of the magnetic portion 7, and FIG. 4B is a plan view of the shape of the magnetic portion 7. The magnetic portion 7 is a member that is formed with an approximately thin plate shape and is accommodated in the housing 3. The magnetic portion 7 is constituted by ferrite as a magnetic body, for example. The magnetic portion 7 is accommodated in the housing 3 in the state of being combined with the conductive portion 10. Examples of ferrite include hard ferrite, soft ferrite, MO.Fe₂O₃ (note that M is a metal ion of Fe, Mn, Zn, Ni, Mg, Co, Cu, or the like), Mn—Zn ferrite, and Ni—Zn ferrite. Note that although ferrite is described as an example of the material used for the magnetic portion 7 in the present embodiment, the present invention is not limited in this way, and another material that has a high magnetic permeability (e.g., an initial magnetic permeability of around 10 to 15000 H/m) may be used. Furthermore, a material that has a high permittivity (e.g., a relative permittivity of around 5 to 20) is more preferable as the material used for the magnetic portion 7. Examples of material that can be used for the magnetic portion 7 include magnet steel, aluminum, nickel, cobalt, soft iron, silicon steel, and amorphous metal.

A groove portion 8 formed so as to be approximately ring-shaped as seen from above is formed in the upper surface of the magnetic portion 7. Specifically, the groove portion 8 is constituted by a circular ring-shaped groove portion 8a formed with the shape of a circular ring with one portion missing (i.e., formed so as to be C-shaped), and a pair of extension groove portions 8b formed so as to extend toward the outside of the magnetic portion 7 from respective end portions of the circular ring-shaped groove portion 8a.

The groove portion 8 is formed with a width (e.g., 1.5 to 2.5 mm) that is longer than the depth of the groove portion 8 (e.g., 0.2 to 0.4 mm). Also, the bottom portion of the groove portion 8 is formed with a flat shape. A circular ring portion 11 and extension portions 16 of the conductive portion 10 that will be described in detail later are fitted into the groove portion 8.

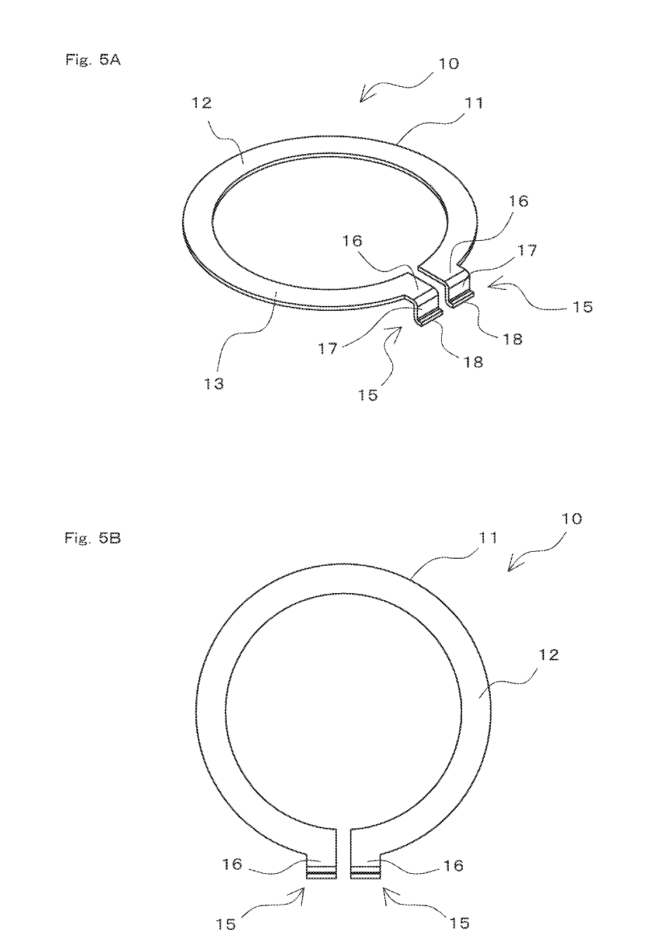

FIG. 5A is a perspective view of the shape of the conductive portion 10, and

FIG. 5B is a plan view of the shape of the conductive portion 10. The conductive portion 10 is a member formed by a metallic material that has conductive properties (e.g., a metal such as aluminum, copper, or iron, or an alloy of these metals). The conductive portion 10 is formed so as to have the shape shown in FIGS. 5A and 5B, by bending a metal plate, which is formed by press punching, for example. Specifically, the conductive portion 10 is formed with the shape of a loop having a winding number of 1. The conductive portion 10 is accommodated in the housing 3, with the exception of terminal portions 15 provided on portions of the conductive portion 10. Note that the surface of the conductive portion 10 has been provided with a coating (coating portion) that has insulating properties in accordance with the conductive properties of the magnetic portion 7. Specifically, if a material having high conductive properties is used for the magnetic portion 7, a coating is needed to electrically insulate the conductive portion 10 and the magnetic portion 7 from each other. However, if a material having low conductive properties is used for the magnetic portion 7, a coating is not needed.

The conductive portion 10 has the circular ring portion 11 and a pair of terminal portions 15, which are all formed as a single body.

The circular ring portion 11 is a portion formed with the shape of a circular ring with one portion missing. In other words, the circular ring portion 11 is formed so as to be shaped as the letter C. The circular ring portion 11 is formed such that the transverse cross-section thereof (the cross-section perpendicular to the extending direction of the circular ring portion 11, that is to say the circumferential direction of the circular ring portion 11) is shaped as a rectangle that is elongated in the diameter direction of the circular ring portion 11. Accordingly, the diameter-direction length of the transverse cross-section of the circular ring portion 11 (e.g., 1.5 to 2.5 mm) is longer than the vertical-direction length of the transverse cross-section (the thickness of the circular ring portion 11, which is 0.2 to 0.4 mm for example).

The terminal portions 15 are tab-shaped portions formed as a single body with the end portions of the circular ring portion 11, and are connected to transmission lines (not shown) of the devices A1 and A2 by soldering or the like. Each terminal portion 15 has an extension portion 16, a perpendicular portion 17, and a foot portion 18, which are all formed as a single body. The extension portions 16 are formed so as to somewhat extend outward in the diameter direction of the circular ring portion 11 from respective end portions of the circular ring portion 11, and the tip portions are exposed to the outside of the housing 3 via the opening portion 6a of the housing 3. The perpendicular portions 17 are bent perpendicularly downward from the tips of the extension portions 16, and extend to the vicinity of the lower surface of the housing 3. The foot portions 18 are bent from the tips of the perpendicular portions 17, and are portions formed so as to somewhat extend outward in the diameter direction of the circular ring portion 11. The foot portions 18 are portions that are soldered to the transmission lines of the devices A1 and A2. The perpendicular portions 17 and the foot portions 18 are exposed to the outside of the housing 3.

As shown in FIGS. 4A, 4B, 5A, 5B, and the like, in each connector 2, the circular ring portion 11 of the conductive portion 10 is fitted into the circular ring-shaped groove portion 8a of the magnetic portion 7, and the extension portions 16 are fitted into the corresponding extension groove portions 8b. Accordingly, a lower surface 13 of the circular ring portion 11 and the lower surfaces of the extension portions 16 are in close contact with the bottom portion of the groove portion 8 of the magnetic portion 7, and the outer circumferential edge portion and the inner circumferential edge portion of the circular ring portion 11 and the edge portions on the two width direction sides of each of the extension portions 16 are in close contact with the magnetic portion 7. In other words, out of the portions of the conductive portion 10 that are accommodated in the housing 3, all of these portions are in close contact with the magnetic portion 7, with the exception of an upper surface 12 of the circular ring portion 11 and the upper surfaces of the extension portions 16. Note that due to dimension error of the conductive portion 10 or the magnetic portion 7, for example, there are cases where the portions other than the upper surface 12 of the circular ring portion 11 and the upper surfaces of the extension portions 16 are not all in close contact with the magnetic portion 7, but rather only partially in close contact with the magnetic portion 7. Also, if the conductive portion 10 has been provided with a coating, the magnetic portion 7 is in close contact with the coating provided on the conductive portion 10, and is not directly in close contact with the conductive portion 10.

Also, with the connector 2, the magnetic portion 7 and the conductive portion 10 with the circular ring portion 11 and the extension portions 16 fitted into the groove portion 8 are accommodated in the housing 3. In this state, the magnetic portion 7 is in close contact with the interior of the housing 3, and the upper surface 12 of the circular ring portion 11 and the upper surfaces of the extension portions 16 are in close contact with the upper surface portion 4 of the housing 3. Note that due to dimension error of the conductive portion 10, the magnetic portion 7, or the housing 3 for example, there are cases where the upper surface 12 of the circular ring portion 11 and the upper surfaces of the extension portions 16 are not all in close contact with the upper surface portion 4 of the housing 3, but rather only partially in close contact with the upper surface portion 4 of the housing 3.

First Device and Second Device Connection State

As shown in FIGS. 1 to 3B, when the first device A1 is to be connected to the second device A2, the first device A1 is set against the second device A2 such that the upper surface portion 4 of the connector 2 built into the first device A1 and the upper surface portion 4 of the connector 2 built into the second device A2 are in contact with each other. At this time, the pair of corresponding connectors 2, 2 are arranged such that the central axes of the conductive portions 10, 10 are in a coaxial state. The conductive portions 10 of the connectors 2 are thus brought near each other (e.g., 0.1 to 1 mm) without being in contact with each other, and the connectors 2 become electrically connected. Specifically, when current flows in the conductive portion 10 of one of the connectors 2 in the above-described state, change over time in the current is accompanied by the generation of a magnetic field that causes current to flow in the conductive portion 10 of the other connector 2. In other words, the pair of connectors 2 are electrically connected to each other by electromagnetic induction (more specifically, mutual induction). Accordingly, the first device A1 and the second device A2 become electrically connected, and data can be transmitted between them. Note that when the central axes of the conductive portions 10, 10 are arranged so as to be in a coaxial state as described above, misalignment of the central axes to the extent of −2 mm to 2 mm, for example, is permitted.

Differential Signal Transmission

Furthermore, according to the electrical connection apparatus 1 of the present embodiment, a differential signal can be transmitted from one connector 2 to the other connector 2.

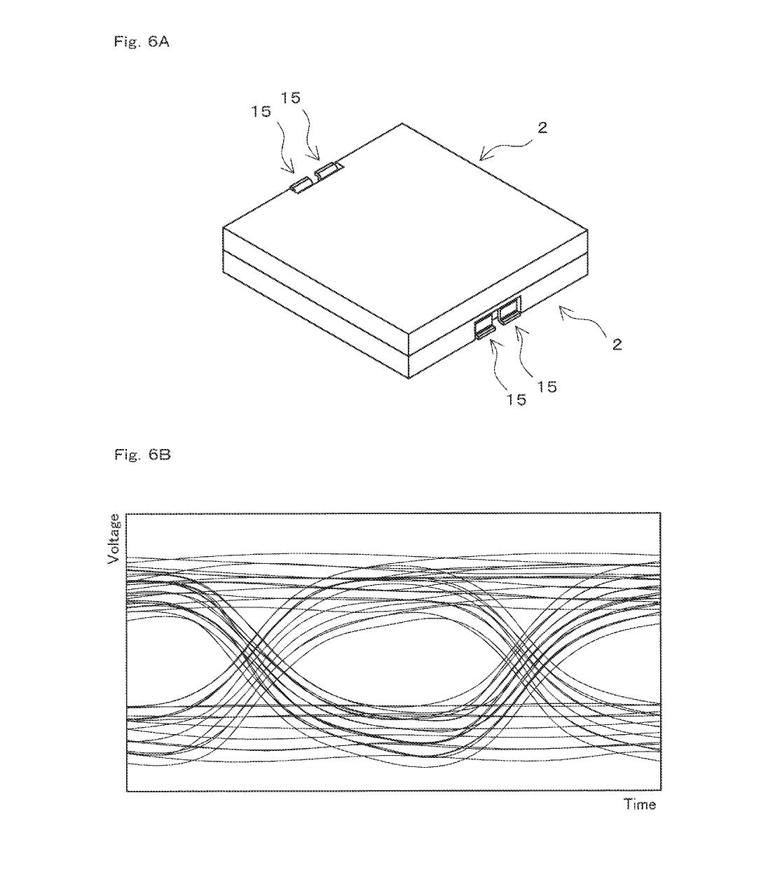

FIGS. 6A and 6B are diagrams for describing the results of simulation of an eye pattern when a differential signal is input from one connector 2 to the other connector 2 by the electrical connection apparatus 1. Specifically, FIG. 6A shows a state in which the terminal portions 15 of the pair of connectors 2 are arranged in directions that are 180 degrees opposite to each other, and FIG. 6B shows the simulation results when the terminal portions 15 of the pair of connectors 2 are in the state shown in FIG. 6A.

In this simulation, a model of the electrical connection apparatus 1 was created with the terminal portions 15 in the orientations shown in FIG. 6A, an electromagnetic analysis was carried out, and the results obtained by this electromagnetic analysis were used to check the eye pattern waveforms obtained when a differential signal with a transmission rate of 5 Gbps was input via one connector 2 to the other connector 2. Note that a pseudorandom pattern with a seven-stage shift register was used as the input pattern.

As shown in FIGS. 6A and 6B, according to the electrical connection apparatus 1 (specifically, according to the electrical connection apparatus 1 in the case where the terminal portions 15 of the pair of connectors 2 are arranged in directions that are 180 degrees opposite to each other), it is possible to obtain a relatively favorable eye pattern. Accordingly, it was confirmed that differential transmission is possible with the electrical connection apparatus 1.

Effects

As described above, with the electrical connection apparatus 1 of the present embodiment, when current flows in one conductive portion 10, change over time in the current is accompanied by the generation of a magnetic field that causes current to flow in the other conductive portion 10. In other words, even if the conductive portions 10 of the pair of connectors 2, 2 are not brought into contact with each other, the pair of connectors 2, 2 can be electrically connected by mutual induction. Accordingly, the conductive portions 10 can be covered by the housings 3 so as to not be exposed to the outside, thus making it possible to provide an electrical connection apparatus that is superior in terms of water resistance, dust resistance, and the like.

Also, in the electrical connection apparatus 1, the conductive portions 10 are formed in the shape of a loop having a winding number of 1, thus making it possible to form the conductive portions 10 with a very simple shape.

Furthermore, if the conductive portions 10 are formed in the shape of a loop having a winding number of 1 as in the electrical connection apparatus 1, it is possible to broaden the transmittable frequency band, unlike the case of conductive portions formed in the shape of a spiral having multiple resonance points. Accordingly, it is possible to cover a broad spectrum (e.g., 100 MHz to 7.5 GHz) with a single electrical connection apparatus 1.

Accordingly, the electrical connection apparatus 1 makes it possible to provide a contactless electrical connection apparatus that has a simple structure and can cover a broad spectrum.

Also, with the electrical connection apparatus 1, by bringing the housings 3 of the connectors 2 into contact with each other, it is possible to bring the conductive portions 10 of the connectors 2 near each other while also preventing the pair of conductive portions 10, 10 from coming into contact with each other. Accordingly, it is possible to reduce the leakage to the outside of magnetic flux generated by change over time in the current flowing in the conductive portion 10 in one of the connectors 2, 2. It is therefore possible to reliably transmit a signal from one connector 2 to the other connector 2. Note that even if the housings 3 of the connectors 2 are not brought into contact with each other, the pair of connectors 2 can be electrically connected by arranging the housings 3 in opposition to each other via another member (substrate etc.) such that the pair of conductive portions 10 oppose each other.

Also, in the electrical connection apparatus 1, wide-area portions of the pair of conductive portions 10, 10 oppose each other. Accordingly, it is possible to broaden the frequency band in which transmission can be performed by the pair of connectors 2, 2. Furthermore, according to the electrical connection apparatus 1, even if there is a certain extent of positional misalignment (e.g., −2 mm to 2 mm) when the pair of conductive portions 10, 10 oppose each other, it is possible to ensure the area of the opposing portions of the pair of conductive portions 10, 10. In other words, the electrical connection apparatus 1 makes it possible to provide an electrical connection apparatus that can permit a certain extent of arrangement misalignment of the pair of connectors 2, 2, positional misalignment of the conductive portions 10 accommodated in the housings 3 relative to the housings 3, and the like.

Also, since the conductive portion 10 is formed in the shape of a circular ring in the electrical connection apparatus 1, the ratio of the area of the portion surrounded by the conductive portion 10 to the peripheral length of the conductive portion 10 can be higher than in the case of a polygon such as a rectangle that has the same peripheral length. This makes it possible to reduce the size of the conductive portion 10 while also ensuring the transmittable frequency band of the electrical connection apparatus 1.

Also, in the electrical connection apparatus 1, the pair of conductive portions 10, 10 are arranged such that their central axes are in a coaxial state, and therefore the magnetic flux formed by current flowing in one conductive portion 10 is likely to penetrate the portion surrounded by the other conductive portion 10. It is therefore possible to more reliably transmit a signal from one connector 2 to the other connector 2.

Also, in the electrical connection apparatus 1, a differential signal input from one connector 2 can be transmitted to the other connector 2, as shown by the results of the above-described simulation.

Also, in the electrical connection apparatus 1, the magnetic portion 7 constituted by ferrite is brought into close contact with the conductive portion 10, thus making it possible to reduce the size of the connector 2 using the wavelength shortening effect.

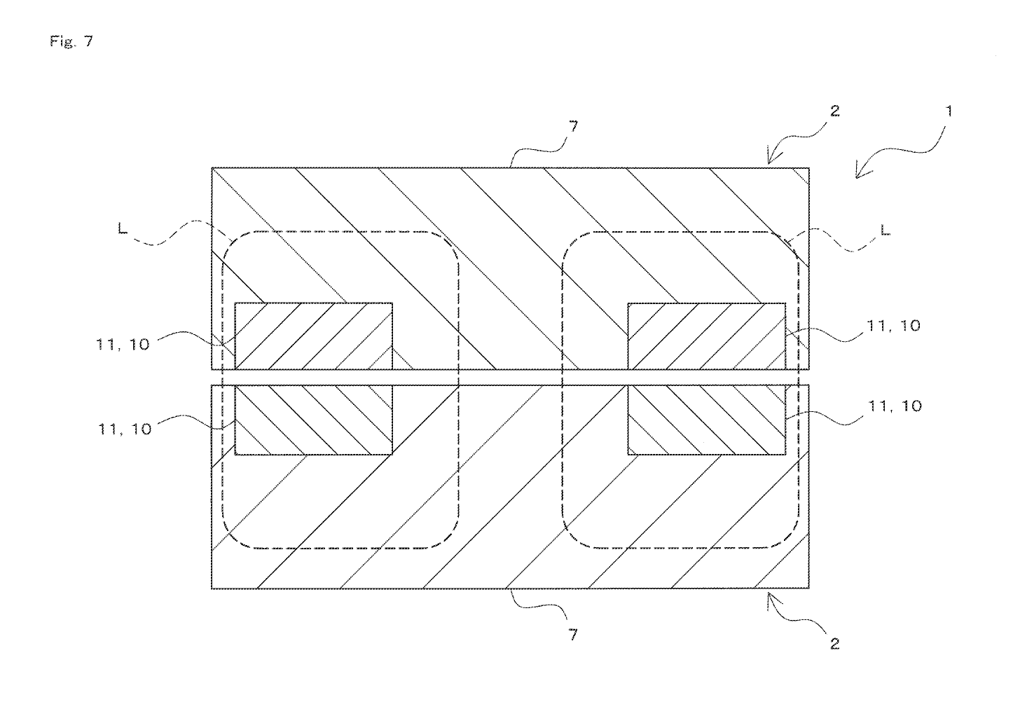

Also, in the electrical connection apparatus 1, the portions of the conductive portion 10 other than the portions that opposes the other conductive portion 10 (specifically, the lower surface 13 of the circular ring portion 11 and the inner circumferential edge portion and the outer circumferential edge portion of the circular ring portion 11) are covered by the magnetic portion 7. Accordingly, when the pair of connectors 2, 2 are connected to each other (i.e., when the pair of conductive portions 10, 10 are brought into opposition so as to be near each other), a closed magnetic circuit L can be virtually formed by the magnetic portions 7 (see FIG. 7). This makes it possible to reduce the leakage of magnetic flux to the outside, thus making it possible to increase the distance between the connectors.

Also, in the electrical connection apparatus 1, the aforementioned closed magnetic circuit L is constituted using magnetic bodies that have a high magnetic permeability (ferrite in the case of the present embodiment). This makes it possible to cause magnetic flux, particularly magnetic flux in the low frequency region, to converge in the closed magnetic circuit L.

Also, with the electrical connection apparatus 1, by appropriately selecting the dimensions of the constituent elements that constitute the electrical connection apparatus 1 (e.g., the shape, size, width, and thickness of the conductive portion 10), the type of materials used for the housing 3 and the magnetic portion 7, for example, it is possible to appropriately configure an electrical connection apparatus that has a size and frequency characteristics in accordance with a user request.

Also, in the electrical connection apparatus 1, there is no need for transmission and reception circuits that have amplifiers, modulation and demodulation circuits, and the like, unlike the case of transmitting and receiving radio waves using a pair of antennas, for example. Accordingly, the configuration of the system in which the electrical connection apparatus 1 is used can be made simpler than in the case of using an antenna.

Although embodiments of the present invention have been described above, the present invention is not limited to these embodiments, and various modifications can be made without departing from the gist of the present invention.

Variations

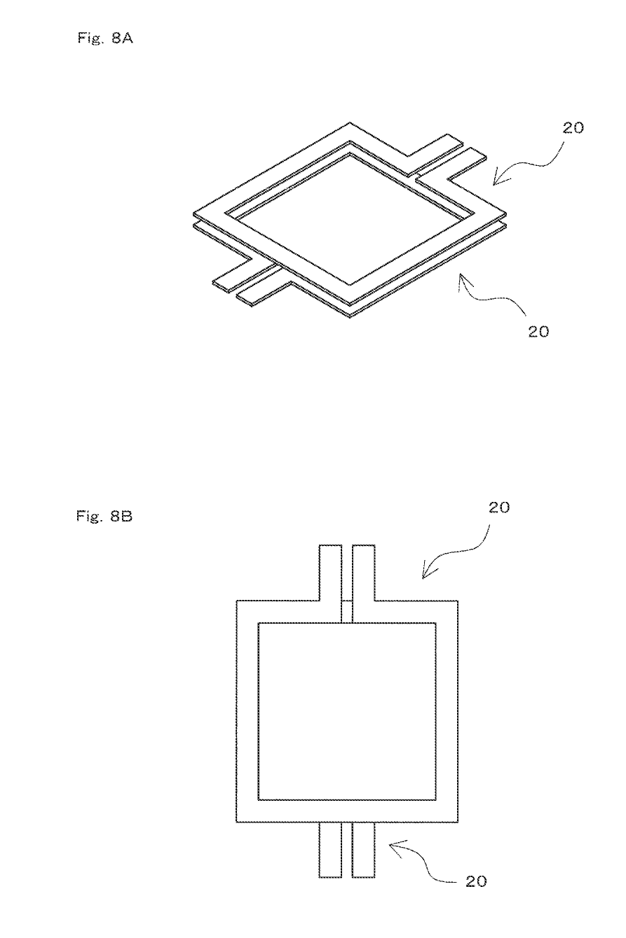

(1) FIG. 8A is a perspective view of the shape of a pair of conductive portions of an electrical connection apparatus according to a variation. Also, FIG. 8B is a plan view of the shape of the pair of conductive portions of the electrical connection apparatus according to this variation. Although the conductive portions 10, 10 are formed in the shape of circular rings in the above embodiment, the present invention is not limited in this way. Specifically, as shown in FIGS. 8A and 8B, a conductive portion 20 may be formed with a rectangular shape in a plan view. Even in this case, similarly to the case of the above embodiment, it is possible to provide a contactless electrical connection apparatus that has a simple structure.

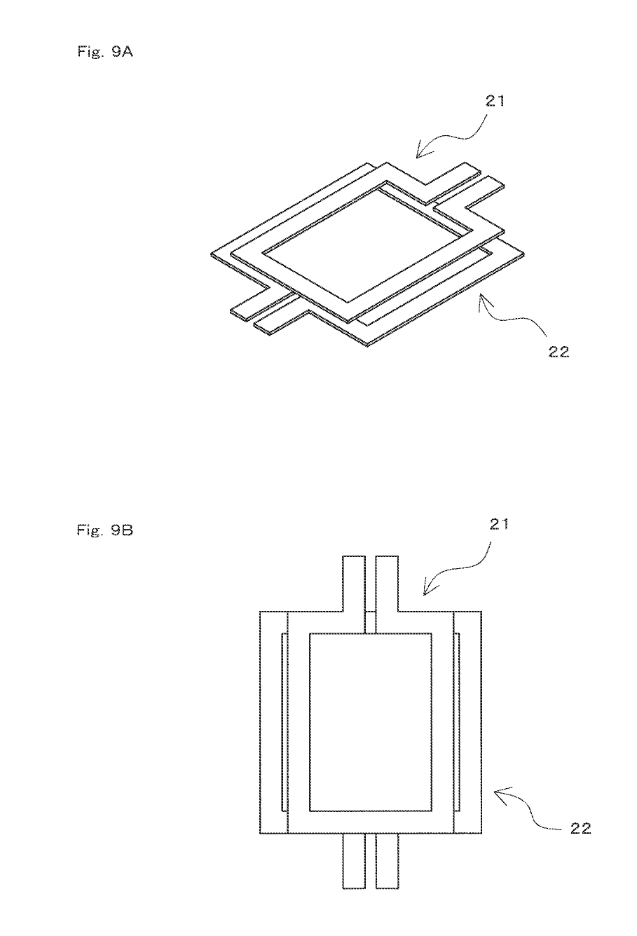

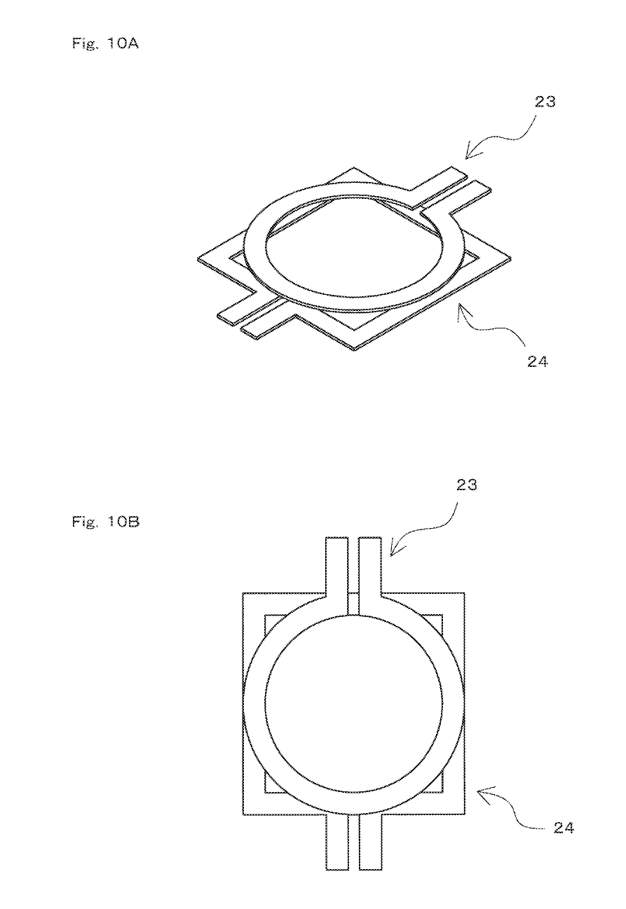

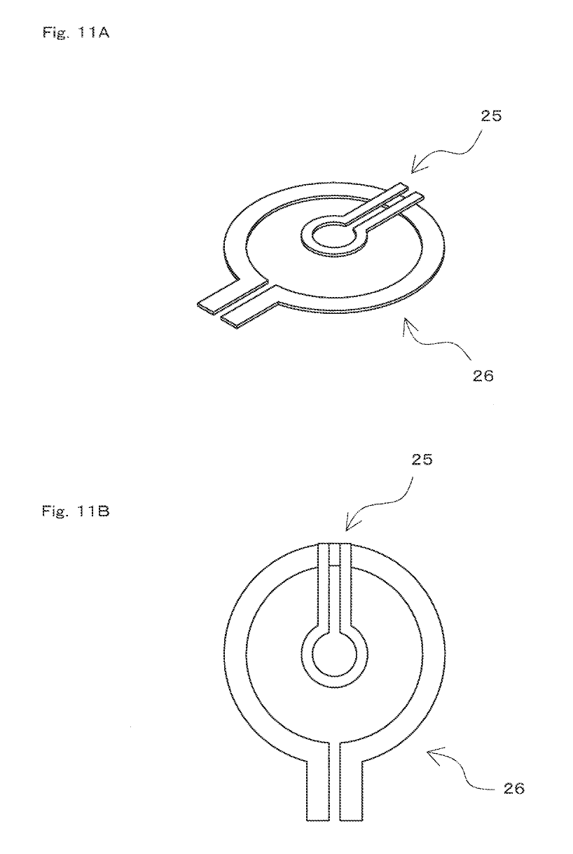

(2) FIGS. 9A, 10A, and 11A are each a perspective view of the shape of a pair of conductive portions of an electrical connection apparatus according to a variation. Also, FIGS. 9B, 10B, and 11B are plan views of the shapes of the pairs of conductive portions of the electrical connection apparatuses according to these variations. Although the pair of conductive portions 10, 10 are formed with the same shape as each other in the above embodiment, the present invention is not limited in this way, and they may have mutually different shapes as shown in FIGS. 9A to 11B. In the example shown in FIGS. 9A and 9B, conductive portions 21 and 22 are all formed with rectangular shapes, but the horizontal length of the one conductive portion 21 is shorter than the horizontal length of the other conductive portion 22. Also, in the example shown in FIGS. 10A and 10B, one conductive portion 23 is formed in the shape of a circular ring, and another conductive portion 24 is formed with a rectangular shape. Also, in the example shown in FIGS. 11A and 11B, conductive portions 25 and 26 are both formed in a circular ring shape, but the outer diameter of the circular ring-shaped portion of the one conductive portion 26 is larger than the outer diameter of the circular ring-shaped portion of the other conductive portion 25. Even in these cases, similarly to the case of the above embodiment, it is possible to provide a contactless electrical connection apparatus that has a simple structure.

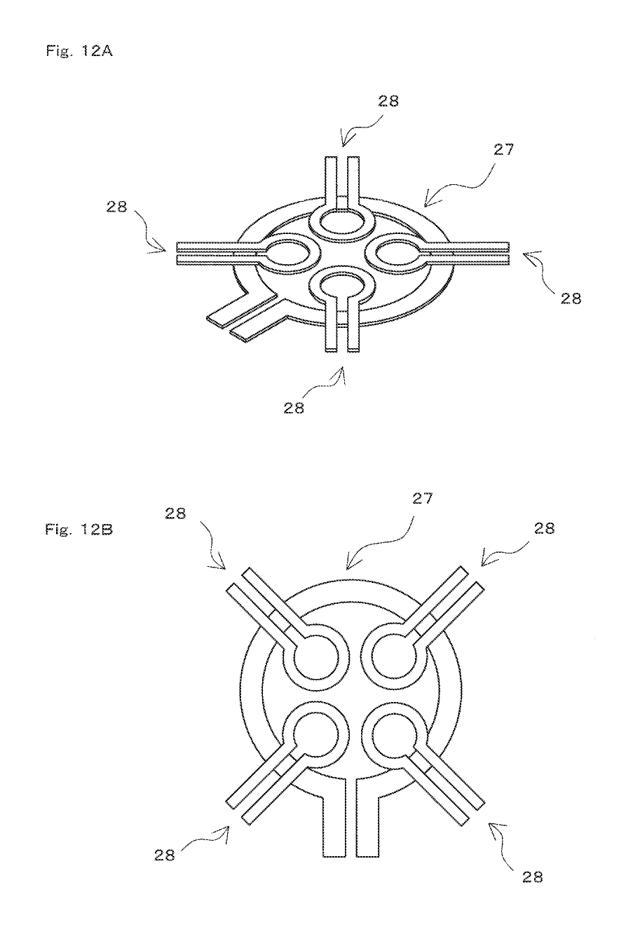

(3) FIG. 12A is a perspective view of the shape of a pair of conductive portions of an electrical connection apparatus according to a variation. Also, FIG. 12B is a plan view of the shape of the pair of conductive portions of the electrical connection apparatus according to this variation. Although the conductive portions are in one-to-one correspondence in the above embodiment and variations, the present invention is not limited in this way. Specifically, multiple (four in the example shown in FIGS. 12A and 12B) conductive portions 28 included in one connector may correspond to one conductive portion 27 included in another connector. Even in this case, similarly to the case of the above embodiment, it is possible to provide a contactless electrical connection apparatus that has a simple structure.

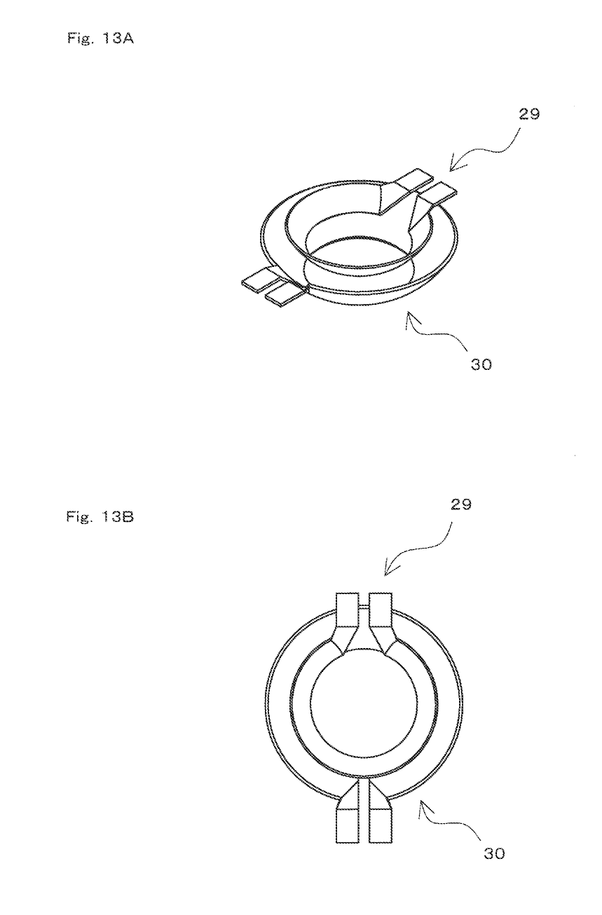

(4) FIG. 13A is a perspective view of the shape of a pair of conductive portions of an electrical connection apparatus according to a variation. Also, FIG. 13B is a plan view of the shape of the pair of conductive portions of the electrical connection apparatus according to this variation. Although the conductive portion is formed with a flat shape in the above-described embodiment and variations, it can be formed with a three-dimensional shape (formed three-dimensionally) as shown in FIGS. 13A and 13B. In the example shown in FIGS. 13A and 13B, conductive portions 29 and 30 are both formed in the shape of a frame that conforms to a spherical surface, and the one conductive portion 29 fits inside the other conductive portion 30. Even in this case, similarly to the case of the above embodiment, it is possible to provide a contactless electrical connection apparatus that has a simple structure.

(5) Although the example of connectors that have a fixed positional relationship with each other in the electrically connected state is described in the above embodiment and variations, the present invention is not limited in this way, and the present invention can be applied to a configuration in which the positional relationship between the connectors can change. Specifically, a configuration is possible in which connectors are provided on rotation mechanisms that have a pair of elements that can rotate relative to each other, the rotation mechanisms are brought near each other, and the rotation mechanisms are driven to rotate using the central axes of the pair of connectors as the center of rotation. This eliminates the need for a cable or the like for electrically connecting the pair of elements that rotate relative to each other, thus making it possible to eliminate the risk of cable disconnection. In particular, if the above-described electrical connection apparatus that has the conductive portions 29 and 30 shown in FIGS. 13A and 13B is applied to the above-described rotation mechanisms, it is possible to achieve a so-called universal joint operation without the use of cables or the like.

(6) Although examples in which the conductive portion has a rectangular or a circular shape are described in the above embodiment and variations, the present invention is not limited in this way, and any shape may be used as long as it is a loop-like shape. Other examples include a quadrangle other than a rectangle (e.g., a square, a trapezoid, or a diamond), a polygon other than a quadrangle (e.g., a triangle or a polygon with five or more sides), and an ellipse.

The present invention is broadly applicable to an electrical connection apparatus for electrically connecting the conductive portions of two connectors to each other without bringing them into contact with each other. The present invention is not limited to the above embodiment, and all modifications, applications, and equivalents thereof that fall within the claims, for which modifications and applications would become naturally apparent by reading and understanding the present specification, are intended to be embraced in the claims.

What is claimed is:

1. An electrical connection apparatus comprising:
a pair of connectors each having a conductive portion shaped as a loop that has a winding number of 1, end portions of the conductive portion being provided as terminal portions,
wherein the pair of connectors are electrically connected by the pair of conductive portions being arranged so as to oppose each other via a gap.

2. The electrical connection apparatus according to claim 1, wherein each of the connectors further has an insulating housing that covers the conductive portion.

3. The electrical connection apparatus according to claim 1,
wherein each of the conductive portions is formed such that a cross-section perpendicular to an extending direction of the conductive portion is shaped as a rectangle, and
the pair of connectors are arranged such that long sides of the cross-sections oppose each other.

4. The electrical connection apparatus according to claim 1, wherein each of the conductive portions is formed in a shape of a circular ring.

5. The electrical connection apparatus according to claim 4, wherein the pair of connectors are arranged such that central axes of the conductive portions formed in a shape of a circular ring are in a coaxial state.

6. The electrical connection apparatus according to claim 1, wherein each of the connectors further has a magnetic portion that is a magnetic body and at least partially comes into close contact with the conductive portion or comes into close contact with a coating portion formed on a surface of the conductive portion.
